(19) United States
(12) Patent Application Publication
(10) Pub. No.: US 2018/0337498 A1
(43) Pub. Date: Nov. 22, 2018

(54) POWER SOCKET SET

(71) Applicant: CYBER POWER SYSTEMS, INC., Taipei City (TW)

(72) Inventors: CHIH-HENG LIN, TAIPEI CITY (TW); CHUAN-HAN HSIAO, TAIPEI CITY (TW)

(73) Assignee: CYBER POWER SYSTEMS, INC., TAIPEI CITY (TW)

(21) Appl. No.: 15/697,050

(22) Filed: Sep. 6, 2017

(30) Foreign Application Priority Data
May 19, 2017 (CN) 201720560224.7

(51) Int. Cl. H01R 25/00; H01R 13/514; H01R 13/10

(52) U.S. Cl. CPC H01R 25/003; H01R 2103/00; H01R 13/10; H01R 13/514

(57) ABSTRACT

A power socket set including a first power socket and a second power socket is provided. The first power socket includes a first base, at least a first type of inserting port and a second type of inserting port. The first type of inserting port and the second type of inserting port are configured in the first base. The second type of inserting port is used to be inserted for a first type of plug or a second type of plug. The second power socket includes one of the first type of plug and the second type of plug for inserting into the second type of inserting port, at least a third type of inserting port and a second base. Wherein, the foregoing first type of plug or second type of plug is configured in the second base. The third type of inserting port is configured in the second base.

### BACKGROUND OF THE INVENTION

### Field of the Invention

The present invention relates to a power socket set, and more particularly, the present invention is relates to a power socket set with power sockets which are easy to combine, and provides various types of inserting port to users for using.

### Description of Related Art

At present, general electrical apparatus are powered through a fixed power socket or a power strip device located in indoor or outdoor for being powered. Wherein, the plug of the electrical apparatus can insert in the inserting port of the fixed power socket or the power strip device.

However, the amount of inserting ports configured in general power socket is limited and have been set. Therefore, the amount of inserting ports is insufficient in the actual use.

In addition, general power socket only provides one type of inserting port to users for using, and is not incompatible with requires which all kinds of electrical products have a dedicated plug. Thus, the current design of general power socket is not convenient for users.

### SUMMARY OF THE INVENTION

Accordingly, an object of the present invention is to provide a power socket set including power sockets which combine easily for providing various types of inserting port to users.

To achieve the foregoing and other objects, a power socket set is provided. The power socket set comprises a first power socket and a second power socket. the first power socket includes a first base, at least a first type of inserting port and a second type of inserting port, wherein the first type of inserting port and the second type of inserting port are configured in the first base, and the second type of inserting port is used to be inserted for a first type of plug or a second type of plug. The second power socket includes one of the first type of plug and the second type of plug, at least a third type of inserting port and a second base, wherein one of the first type of plug and the second type of plug and the third type of inserting port are configured in the second base, and the second type of inserting port is inserted by one of the first type of plug and the second type of plug.

In one embodiment of the present invention, the power socket set further comprises a third power socket, the third power socket includes one of the first type of plug and the second type of plug, at least a fourth type of inserting port, the second type of inserting port and a third base, one of the first type of plug and the second type of plug, the fourth type of inserting port and the second type of inserting port are configured in the third base.

In one embodiment of the present invention, the second power socket includes the first type of plug, the third power socket includes the second type of plug, and the second type of plug of the third power socket inserts in the second type of inserting port of the first power socket, the first type of plug of the second power socket inserts in the second type of inserting port of the third power socket.

In one embodiment of the present invention, the fourth type of inserting port and the first type of inserting port are the same type.

In one embodiment of the present invention, the fourth type of inserting port and the first type of inserting port are different types.

In one embodiment of the present invention, at least one of the first type of inserting port and the second type of inserting port is a composite type of inserting port.

In one embodiment of the present invention, the composite type of inserting port is provided to insert for at least two types of plug.

In one embodiment of the present invention, the third type of inserting port is provided for coupling with a power cable of a portable electronic device.

In one embodiment of the present invention, at least one of the first base, the second base and the third base is configured with a supporting mechanism for supporting the portable electronic device.

In one embodiment of the present invention, at least one of the first base, the second base and the third base is configured with a connecting mechanism for connecting another of the first base, the second base and the third base.

In the present invention, the second type of inserting port is configured in the first power socket for being inserted by the first type of plug or the second type of plug. Therefore, the second power socket having the first type of plug or the second type of plug can be combined with the first power socket easily, and further provides various inserting ports to users for using.

In addition, in the present invention, because the second power socket is configured with the first type of plug or the second type of plug, thus the second power socket of the present invention also can be used individually for inserting in the power outlet located on wall, and is not affected by failure or damage of the first power socket.

Besides, in the present invention, base on characteristics which all power socket of the power socket set are combined easily with each other, thus each power socket can be configured with suitable specification of inserting port that meets the needs of users. Therefore, when these power sockets of the present invention are combined, users can use the corresponding electrical apparatus without any adapter.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a power socket set according to one embodiment of the present invention.

FIG. 2 is a schematic view illustrating a power socket set according to one embodiment of the present invention.

FIG. 3 is a schematic view illustrating the first power socket and the second power socket according to one embodiment of the present invention.

FIG. 4A is a schematic view illustrating the first power socket and the second power socket according to one embodiment of the present invention.

FIG. 4B is a magnified schematic view of the R region in FIG. 4A.

FIG. 5 is a schematic view illustrating the second power socket and a portable electronic device according to one embodiment of the present invention.

FIG. 6A and FIG. 6B are schematic views illustrating the second power socket according to one embodiment of the present invention.

### DESCRIPTION OF EMBODIMENTS

The characteristics, contents, advantages and achieved effects of the present invention will become more fully understood from the detailed description given herein below and the accompanying drawings which are given by way of illustration only, and thus are not limitative of the present invention.

As required, detailed embodiments are disclosed herein. It must be understood that the disclosed embodiments are merely exemplary of and may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

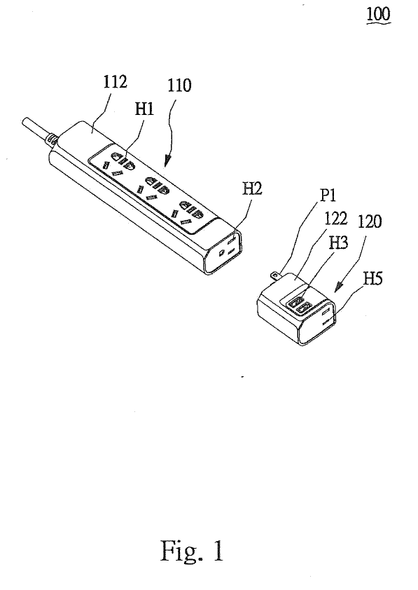

FIG. 1 is a schematic view illustrating a power socket set according to one embodiment of the present invention. Referring to FIG. 1, the power socket set 100 of the present embodiment includes a first power socket 110 and a second power socket 120. The first power socket 110 includes a first base 112, at least a first type of inserting port H1 and a second type of inserting port H2. Wherein, the first type of inserting port H1 and the second type of inserting port H2 are configured in first base 112, and the second type of inserting port H2 is inserted by one of a first type of plug P1 or a second type of plug P2 (not shown in FIG. 1). The first type of plug P1 is, for example, a plug with two pins. The second type of plug P2 is, for example, a plug with three pins. The second power socket 120 includes at least one of the first type of plug P1 and the second type of plug P2, at least a third type of inserting port H3 and a second base 122. The second power socket 120 further includes a fifth inserting port H5. Wherein, at least one of the first type of plug P1 and the second type of plug P2 and the third type of inserting port H3 are configured in the second base 122. At least one of the first type of plug P1 and the second type of plug P2 inserts in the second type of inserting port H2.

In the present embodiment, the second power socket 120 is configured with the first type of plug P1. In other words, the second power socket 120 can inserts in the second type of inserting port H2 of the first power socket 110 through the first type of plug P1 for combining the second power socket 120 and the first power socket 110. In addition, the third type of inserting port H3 of the present embodiment can be provided for coupling with a power cable of a portable electronic device (not shown in FIG. 1). Therefore, when the second power socket 120 and the first power socket 110 are combined, the second power socket 120 can be as a extended member of the first power socket 110. Further, users can create different combinations according to various needs. Wherein, the first type of plug P1 and the fifth inserting port H5 are, for example, configured in two opposite sides of the second base 122.

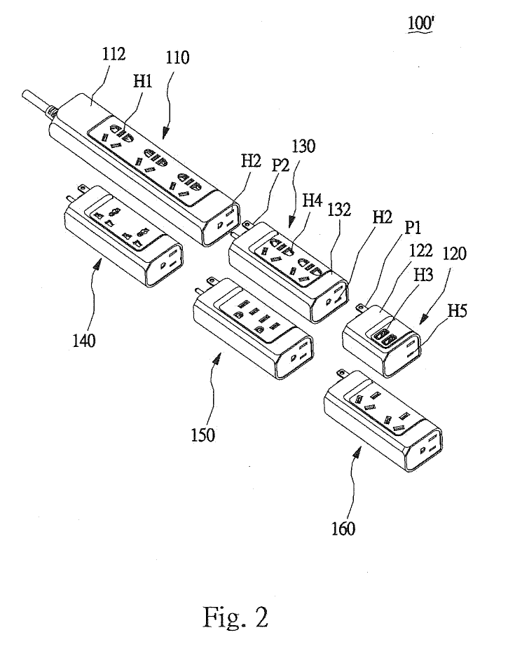

FIG. 2 is a schematic view illustrating a power socket set according to one embodiment of the present invention. Referring to FIG. 2, the power socket set 100 of the present embodiment further includes a third power socket 130. The third power socket 130 includes at least one of the first type of plug P1 and the second type of plug P2, at least a fourth type of inserting port H4, the second type of inserting port H2 and a third base 132. At least one of the first type of plug P1 and the second type of plug P2, the fourth type of inserting port H4, and the second type of inserting port H2 are configured in third base 132.

Wherein, in the present embodiment, the second power socket 120 includes the first type of plug P1. The third power socket 130 includes the second type of plug P2. The second type of plug P2 of the third power socket 130 inserts in the second type of inserting port H2 of the first power socket 110. The first type of plug P1 of the second power socket 120 inserts in the second type of inserting port H2 of the third power socket 130. In other words, the third power socket 130 and the second power socket 120 can be combined with the first power socket 110 in sequential. The third power socket 130 and the second power socket 120 can be as the extended members of the first power socket 110. Further, users can create different combinations according to various needs. Wherein, in another preferred embodiment, the sequence of all power sockets combined with the first power socket 110 can be adjusted appropriately, and the present invention will not be limited to this.

In the present embodiment, the fourth type of inserting port H4 and the first type of inserting port H1 are the same type. Therefore, the power socket set 100 of the present embodiment can be extended to have multiple inserting ports with the same type for using. Certainly, the fourth type of inserting port H4 also can be different from the first type of inserting port H1. Simply, in the power socket set 100 of the present embodiment, the first power socket 110 further can be combined with power socket 140, 150, 160. Wherein, the inserting port of the power socket 140, 150, or 160 is, for example, different from the first type of inserting port H1. Similarly, the power socket 140, 150, 160 also can be the extended member of the first power socket 110. Further, users can create different combinations according to various needs.

In addition, in the third power socket 130, the second type of inserting port H2 and the second type of plug P2 are, for example, configured in two opposite sides of the third base 132. Wherein, although the first power socket 110 and the third power socket 130 shown in FIG. 2 are configured with the second type of inserting port H2, but the second type of inserting port H2 configured in the third power socket 130 also can be change to the fifth inserting port H5 in other preferred embodiments, and the inserted plug also can be changed correspondingly. Similarly, the fifth inserting port H5 configured in the second power socket 120 also can be change to the second type of inserting port H2, and the inserted plug also can be changed correspondingly. In other words, the present invention will not be limited to type of plug configured in the power socket.

Besides, although the second power socket 120 shown in FIG. 2 is configured with the first type of plug P1, but the second power socket 120 also can configured with the second type of plug P2 in other preferred embodiments. Similarly, except to configure with the second type of plug P2, the third power socket 130 also can be configured with the first type of plug P1. In other words, the present invention will not be limited to type of plug configured in the power socket.

In one preferred embodiment, at least one of the first type of inserting port H1 and the second type of inserting port H2 is, for example, a composite type of inserting port. The composite type of inserting port is provided to insert for at least two types of plug.

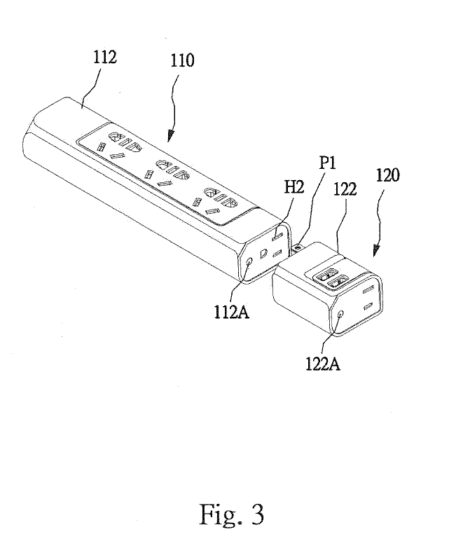

FIG. 3 is a schematic view illustrating the first power socket and the second power socket according to one embodiment of the present invention. Referring to FIG. 3, in the first power socket 110 of the present embodiment, at least a first connecting mechanism 112A is, for example, configured in the first base 112. Relatively, in the second power socket 120, at least a second connecting mechanism 122A is, for example, configured in the second base 122. Wherein, the second connecting mechanism 122A is configured in the surface of the second base 122 toward the first power socket 110. Wherein, the first connecting mechanism 112A and the second connecting mechanism 122A of the present embodiment are, for example, magnetic structures. Thus, the first power socket 110 and the second power socket 120 can be connected effectively and stably through magnetic effect between the first connecting mechanism 112A and the second connecting mechanism 122A. Further, the second type of inserting port H2 and the first type of plug P1 can be combined securely to keep the electrical connecting relationship.

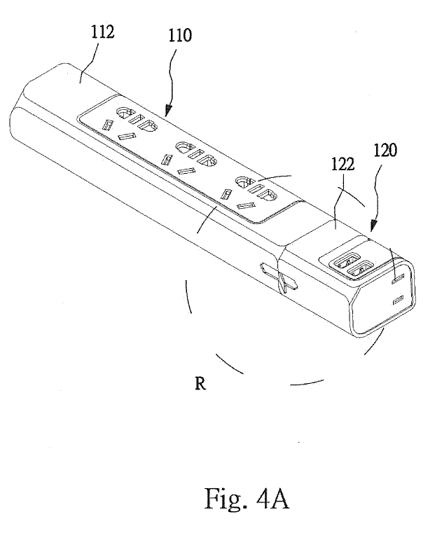

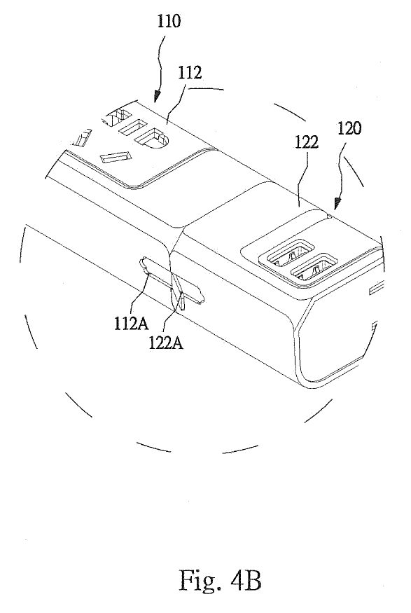

FIG. 4A is a schematic view illustrating the first power socket and the second power socket according to one embodiment of the present invention. FIG. 4B is a magnified schematic view of the R region in FIG. 4A. Referring to FIG. 4A and FIG. 4B, in the present embodiment, the first connecting mechanism 112A is, for example, a fastening groove configured in the first base 112, and the second connecting mechanism 122A is, for example, a fastening element configured in the second base 112. In detail, in the second power socket 120, the second connecting mechanism 122A is, for example, pivoted in the second base 122. Therefore, when the first power socket 110 and the second power socket 120 are combined for coupling the second type of inserting port H2 and the first type of plug P1, the second connecting mechanism 122A can rotate for fastening in the first connecting mechanism 112A of the first base 112. Further, the second type of inserting port H2 and the first type of plug P1 can be connected stably to keep the electrical connecting relationship.

As shown in FIG. 3, FIG. 4A and FIG. 4B, in the present invention, at least one of the first base 112 and the second base 122 can configures with one connecting mechanism for connecting the adjacent first base 112 or the second base 122. Certainly, in another preferred embodiment, at least one of the first base 112, the second base 122 and the third base 132 also can be configured with one connecting mechanism for connecting another of the first base 112, the second base 122 and the third base 132, and the present invention will not be limited to this.

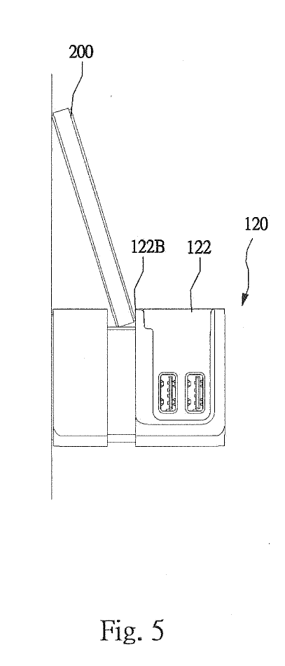

FIG. 5 is a schematic view illustrating the second power socket and a portable electronic device according to one embodiment of the present invention. Referring to FIG. 5, in the present embodiment, the second base 122 can be configured with a supporting mechanism 122B for supporting the portable electronic device 200. In other words, the second power socket 120 can inserts in suitable power supply location (like wall socket) directly, and the portable electronic device 200 can be placed in the supporting mechanism 122B of the second base 122 for using or charging by users. Certainly, in another preferred embodiment, at least one of the first base 112, the second base 122 and the third base 132 can be configured with the supporting mechanism for supporting the portable electronic device 200, and the present invention will not be limited to this.

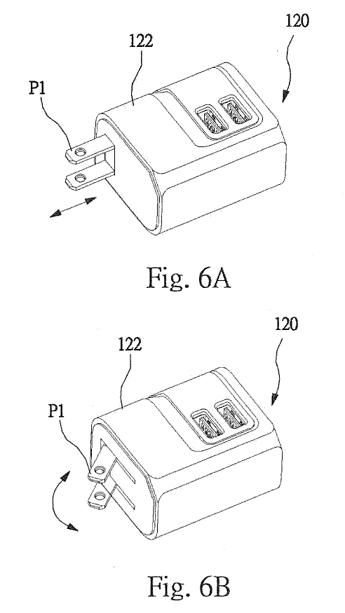

FIG. 6A and FIG. 6B are schematic views illustrating the second power socket according to one embodiment of the present invention. Referring to FIG. 6A and FIG. 6B, the second power socket 120 of the present embodiment, the first type of plug P1 can be, for example, accommodated in the second base 122 by horizontal slipping (as shown in FIG. 6A) and pivoting way (as shown in FIG. 6B).

To sum up, in the present invention, the second type of inserting port is configured in the first power socket for being inserted by the first type of plug or the second type of plug. Therefore, the second power socket having the first type of plug or the second type of plug can be combined with the first power socket easily, and further provides various inserting ports to users for using.

In addition, in the present invention, because the second power socket is configured with the first type of plug or the second type of plug, thus the second power socket of the present invention also can be used individually for inserting in the power outlet located on wall, and is not affected by failure or damage of the first power socket.

Besides, in the present invention, the configuration of the connecting mechanism can keep the electrical connecting relationship configured between the inserting port and the plug securely when two adjacent power sockets are combined.

Besides, in the present invention, base on characteristics which all power socket of the power socket set are combined easily with each other, thus each power socket can be configured with suitable specification of inserting port that meets the needs of users. Therefore, when these power sockets of the present invention are combined, users can use the corresponding electrical apparatus without any adapter.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A power socket set, comprising:
a first power socket, including a first base, at least a first type of inserting port and a second type of inserting port, wherein the first type of inserting port and the second type of inserting port are configured in the first base, and the second type of inserting port is configured to receive both a first type of plug and a second type of plug;
a second power socket, including the first type of plug, and at least a third type of inserting port and a second base, wherein the first type of plug and the third type of inserting port are configured in the second base; and
a third power socket;
wherein the third power socket includes the second type of plug, at least a fourth type of inserting port, the second type of inserting port and a third base; and the second type of plug, the fourth type of inserting port and the second type of inserting port are configured in the third base,
wherein the second type of plug of the third power socket is configured to be inserted into the second type of inserting port of the first power socket, and the first type of plug of the second power socket is configured to be inserted into the second type of inserting port of the third power socket, and
wherein a structure of the first type of plug differs from a structure of the second type of plug at least in that a number of pins of the first type of plug is different from the number of pins of the second type of plug.

2. (canceled)

3. (canceled)

4. The power socket set according to claim 1, wherein the fourth type of inserting port and the first type of inserting port are the same type.

5. The power socket set according to 1, wherein the fourth type of inserting port and the first type of inserting port are different types.

6. The power socket set according to claim 1, wherein the at least one of the first type of inserting port and the second type of inserting port is a composite type of inserting port.

7. The power socket set according to claim 6, wherein the composite type of inserting port is configured to receive at least the two types of plug.

8. The power socket set according to claim 1, wherein the third type of inserting port is provided for coupling with a power cable of a portable electronic device.

9. The power socket set according to claim 1, wherein the at least one of the first base, the second base and the third base is configured with a supporting mechanism for supporting the portable electronic device.

10. The power socket set according to claim 1, wherein at least one of the first base, the second base and the third base is configured with a connecting mechanism for connecting another of the first base, the second base and the third base.
